(19) United States
(12) Patent Application Publication
(10) Pub. No.: US 2019/0243596 A1
(43) Pub. Date: Aug. 8, 2019

(54) SCREEN DISPLAY SERVER AND PROGRAM THEREOF

(71) Applicant: Konica Minolta, Inc., Tokyo (JP)

(72) Inventors: Tatsuya Kawano, Tokyo (JP); Kazuhisa Kishimoto, Tokyo (JP)

(73) Assignee: Konica Minolta, Inc., Tokyo (JP)

(21) Appl. No.: 16/253,443

(22) Filed: Jan. 22, 2019

(30) Foreign Application Priority Data
Feb. 7, 2018 (JP) 2018-020199

(51) Int. Cl. G06F 3/147; G09G 3/36; G06F 21/31

(52) U.S. Cl. CPC G06F 3/147; G09G 3/36; G06F 21/31; G09G 2330/021; G09G 2370/042; G09G 2320/066; G09G 2360/16; G09G 2370/16; G09G 2370/02; G09G 2320/0666

(57) ABSTRACT

A screen display server includes: a hardware processor that accepts a request for display data of a screen from a client terminal; acquires display mode information of a display of the client terminal; selects, when display is performed on a display with the display mode indicated by the acquired display mode information, an image type with the lowest power consumption related to display from a plurality of predetermined image types; and generates the display data of the screen based on the selected image type and provides the generated display data to the client terminal.

The entire disclosure of Japanese patent Application No. 2018-020199, filed on Feb. 7, 2018, is incorporated herein by reference in its entirety.

### BACKGROUND

### Technological Field

The present invention relates to a screen display server for transmitting display data to a client terminal to display a screen and a program thereof.

### Description of the Related Art

There is a technique called a WebUI as a technique of remotely operating an image forming apparatus such as a multifunction copier from a portable terminal. This means that an image forming apparatus provided with a Web server function transmits display data of an operation screen in an HTML format to a portable terminal such as a tablet, the portable terminal which has received the display data displays the operation screen on a browser and returns information on an operation received from a user to the Web server of the image forming apparatus, and thus the image forming apparatus receives a setting operation of a job from a remote portable terminal.

The portable terminal is generally battery-driven. Therefore, it is demanded to save power consumption related to display of the screen which occupies a large percentage of the power consumption in the portable terminal.

As a technique for accepting this demand, for example, in JP 2011-75821 A, there is disclosed a display apparatus in which the gradation conversion for brightening the halftone of a part of an area in the screen is performed to improve visual luminance, and the brightness of a backlight of that area by that amount is lowered to reduce power consumption.

Also, there is provided a method of reducing power consumption without changing hue because, in a case where the average luminance of image data is more than a predetermined value, the image data obtained by inverting a luminance component of the image data is generated and displayed on an image display (see JP 2013-168703 A).

By the way, as a mode of a liquid crystal panel used for the display of a portable terminal, there are provided a mode in which a black screen is displayed (normally black) such that transmittance or reflectance becomes the lowest when no voltage is applied to a liquid crystal, and a mode in which a white screen is displayed (normally white) such that the transmittance or reflectance becomes the highest when no voltage is applied to the liquid crystal. Due to a difference in these modes, generally, there are characteristics in that in the former mode, it is better to display dark colors, and in the latter mode, it is better to display light colors, thereby reducing power consumption.

In JP 2014-95752 A, as a technique for reducing the power consumption related to display by utilizing these characteristics, there is disclosed a method in which, in a case where a display mode of a display of a terminal is a normally white mode, a white direction is determined as a shift direction and in a case where the display mode is a normally black mode, a black direction is determined as a shift direction so that an image subjected to level-shifting by an appropriate shift amount in the determined shift direction is displayed on the display.

Since, although it is possible to reduce power consumption related to screen display by utilizing the characteristics of the normally black mode and the normally white mode, a WebUI server in the related art provides the same display data without depending on whether the client terminal is a normally black mode or a normally white mode, there is a case where the power consumption increases according to the mode of the liquid crystal panel on a portable terminal side.

In order to reduce power consumption related to screen display on a portable terminal, the techniques disclosed in JP 2011-75821 A, JP 2013-168703 A and JP 2014-95752 A require special hardware or cost a large processing burden on the portable terminal side. Therefore, it has not been possible to obtain an effect of reducing power consumption widely in any portable terminal.

### SUMMARY

One or more embodiments of the present invention provide a screen display server and a program thereof in which an effect of reducing power consumption related to screen display is widely achievable in client terminals without special hardware or the like.

A screen display server according to one or more embodiments of the present invention comprises a hardware processor that: accepts a request for display data of a screen from a client terminal; acquires display mode information of a display of the client terminal which is a transmission source of the request accepted by the hardware processor; selects an image type with the lowest power consumption related to display from a plurality of predetermined image types, in a case where display is performed on a display of a display mode indicated by the display mode information acquired by the hardware processor; and generates display data of a screen as the image type selected by the hardware processor according to the request and provides the display data to the client terminal.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration example of a system that is provided with an image forming apparatus including a screen display server according to one or more embodiments of the present invention and a client terminal for remotely operating the image forming apparatus;

FIG. 2 is a block diagram illustrating a schematic configuration of an image forming apparatus including a screen display server according to one or more embodiments of the present invention;

FIG. 3 is a diagram illustrating a scene in which display data of a screen is generated from a background image and an object image for a normally white mode stored in an image component storage according to one or more embodiments;

FIG. 4 is a diagram illustrating a scene in which display data of a screen is generated from a background image and an object image for a normally black mode stored in an image component storage according to one or more embodiments;

FIG. 5 is a diagram illustrating an example of a setting table according to one or more embodiments;

FIG. 6 is a flowchart schematically illustrating operations performed in a case where an image forming apparatus receives a screen acquiring request from a client terminal according to one or more embodiments;

FIG. 7 is a flowchart illustrating details of display mode determination processing (step S103 in FIG. 6) according to one or more embodiments;

FIG. 8 is a flowchart illustrating details of image type selection processing (step S105 in FIG. 6) according to one or more embodiments;

FIG. 9 is a flowchart illustrating details of conversion excluded area determination processing (step S106 in FIG. 6) according to one or more embodiments; and

FIG. 10 is a flowchart illustrating processing performed in a case where an operation screen is displayed on an operation display of an image forming apparatus according to one or more embodiments.

### DETAILED DESCRIPTION

Hereinafter, embodiments of the present invention will be described with reference to the drawings. However, the scope of the invention is not limited to the disclosed embodiments.

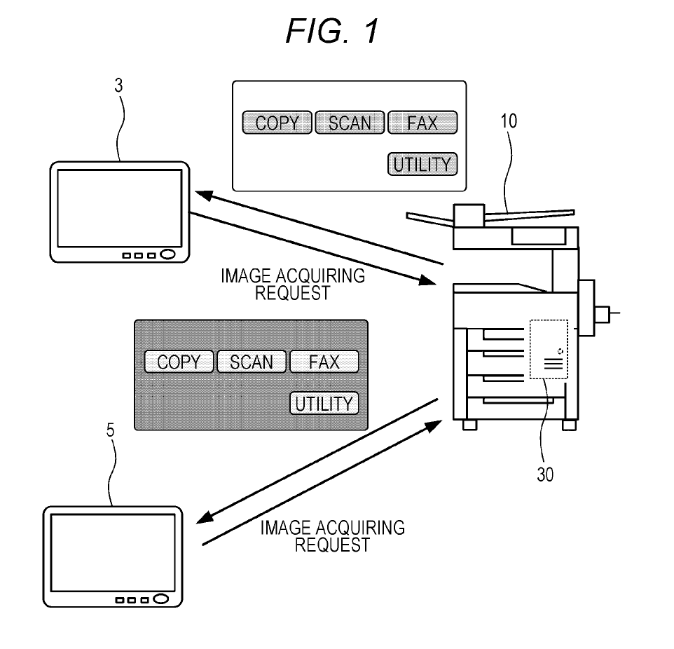

FIG. 1 is a diagram illustrating a configuration example of a system according to one or more embodiments of the present invention. This system includes an image forming apparatus 10, and client terminals 3 and 5 that are communicably connected to the image forming apparatus 10 and can remotely operate the image forming apparatus 10.

The client terminals 3 and 5 are a mobile information processing terminal such as a tablet. The client terminal 3 has a display in a normally white mode (“a white mode”), and the client terminal 5 has a display in a normally black mode (“a black mode”).

The image forming apparatus 10 is a so-called multifunction copier having a copy function of printing an image obtained by reading a document with a scanner on a paper sheet, a scan function of converting an image obtained by reading with a scanner into a file and sending the image to the outside or storing the image in an internal storage, a facsimile function of sending and receiving an image in accordance with a facsimile communication procedure, a print function of printing out an image based on the received print data on a paper sheet, and the like. Further, the image forming apparatus 10 has a function as a Web server (a screen display server 30) for providing a WebUI function.

The WebUI function is a function in which display data (in an HTML format) of an operation screen is transmitted to an external client terminal, and the client terminal that has received the display data displays the operation screen on a browser, and returns information on an operation received from a user to the screen display server 30 of the image forming apparatus 10 so that job setting operation and the like is received from a remote client terminal. The WebUI function performs the transmission of display data of the operation screen by using an HTTP protocol and the like.

The operation screen to be provided to the client terminal by the WebUI function has the same display contents as those of the operation screen to be displayed on an operation display 14 of the own apparatus (a screen in which the same function is achievable). In this way, the user can perform remote control from the client terminal with the same operability as that of a case where an operation is performed on a familiar operation panel of the image forming apparatus 10.

The screen display server 30 of the image forming apparatus 10 generates and transmits display data of a screen as an image type with low power consumption in a case where the screen is displayed in white mode, to the client terminal 3 having a display in the white mode, and generates and transmits display data of a screen as an image type with low power consumption in a case where the screen is displayed in black mode when display data of the screen is transmitted to the client terminal 5 having a display in the black mode. That is, the screen display server 30 switches display data to be transmitted to a client terminal, according to a display mode of a display of the client terminal of a transmission destination, even in a case of the screen having the same function.

Specifically, in a case where the display of the client terminal of the transmission destination has the white mode, an image type with high average luminance is selected, as compared with a case where the display of the client terminal of the transmission destination has the black mode. On the other hand, in a case where the display of the client terminal of the transmission destination has the black mode, an image type with low average luminance is selected, as compared with a case where the display of the client terminal of the transmission destination has the white mode. That is, in a case where display on the display in that mode is performed, an image type with low power consumption related to display is selected.

In this way, on a screen display server 30 side, the image type of the screen to be transmitted to the client terminal is selected according to the display mode of the client terminal or the like, so that on a client terminal side, it is possible to reduce power consumption related to screen display in each client terminal without preparing special hardware or executing processing with a heavy load.

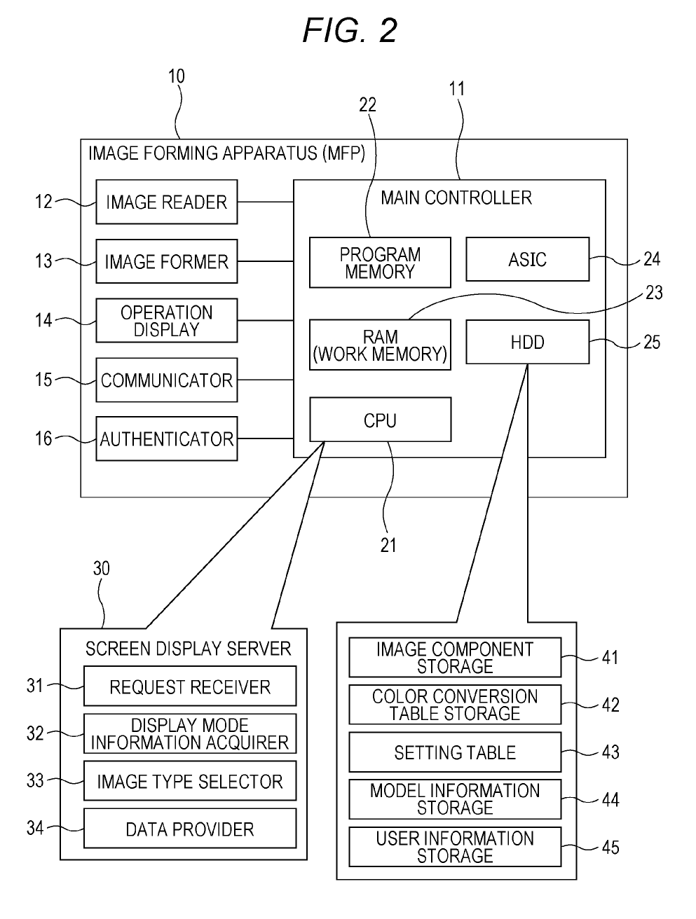

FIG. 2 is a block diagram illustrating a schematic configuration of the image forming apparatus 10. The image forming apparatus 10 is configured by connecting an image reader 12, an image former 13, an operation display 14, a communicator 15, an authenticator 16, and the like to a main controller 11.

The main controller 11 is a controller that totally controls operations of the entire image forming apparatus 10. The image reader 12 performs functions of optically reading a document and acquiring image data. The image former 13 performs a function of image-forming (printing) an image according to image data on a paper sheet. Herein, the image former is configured as a so-called laser printer having a sheet transporting apparatus, a photoreceptor drum, a charging apparatus, a laser unit, a developing apparatus, a transfer separating apparatus, a cleaning apparatus, and an anchoring apparatus, and forming an image in an electrophotography process. The image former 13 may be configured in other manners.

The operation display 14 includes an operator and a display, and performs functions of displaying various operation screens and setting screens, and receiving various operations from the user. The display is configured with a liquid crystal display, and the operator is configured with various hard keys such as a start button and ten key, and a touch screen and the like provided on a display surface of the display.

The communicator 15 performs functions of transmitting and receiving various data to and from external apparatuses such as the client terminals 3 and 5, and the cloud server, through a network. The network may be implemented using a wireless LAN network, Bluetooth (registered trademark), or the like stipulated by IEEE 802.11. However, the network may be implemented using any form as long as mutual data communication is implementable.

The authenticator 16 authenticates a user that uses the image forming apparatus 10. An optional authentication method such as an ID and password, and biometric authentication is used.

The main controller 11 is configured with a Central Processing Unit (CPU) 21, a program memory 22, a Random Access Memory (RAM) 23, an ASIC 24, an HDD 25, and the like.

The CPU 21 is based on an OS program and executes middleware, application programs, and the like thereon. Various programs are stored in the program memory 22, and the CPU 21 executes various processing according to these programs.

The RAM 23 is used as a work memory for temporarily storing various data and an image memory for storing image data in a case where the CPU 21 executes processing based on a program. The ASIC 24 executes image processing and the like at high speed by hardware. The HDD 25 is a nonvolatile storage apparatus with large capacity.

The CPU 21 functions as the screen display server 30 by executing a program. The screen display server 30 is configured to be connected to a single client terminal or a plurality of client terminals into which screen data is able to be distributed, and is able to accept a screen acquiring request from each client terminal asynchronously, generate a screen for each client terminal, and distribute the screen into each client terminal.

The screen display server 30 is configured with a request receiver 31, a display mode information acquirer 32, an image type selector 33, a data provider 34, and the like.

The request receiver 31 analyzes the information received by the communicator 15 and accepts a request (screen acquiring request) for display data of the screen from the client terminal. The display mode information acquirer 32 performs a function of acquiring display mode information of the display of the client terminal which is a transmission source of the screen acquiring request accepted by the request receiver 31.

In a case where the image type selector 33 performs display on the display in the display mode indicated by the display mode information acquired by the display mode information acquirer 32, from a plurality of predetermined image types, an image type with the lowest power consumption related to display is selected. Herein, in a case where display is performed on the display in white mode, an image type with low power consumption is set to a first image type, and in a case where display is performed on the display in black mode, an image type with low power consumption is set to a second image type.

The data provider 34 generates display data of a requested screen of the image type selected by the image type selector 33, and transmits the display data to a requesting source. The data provider 34 generates display data from which the screen having the same function is able to be displayed, regardless of the selected image type.

The HDD 25 functions as an image component storage 41, a color conversion table 42, a setting table 43, a model information storage 44, and a user information storage 45. For each image type, the image component storage 41 previously stores contents such as a background image configuring a screen or an object image such as an operation button disposed to overlap with the background image. The display data such as various operation screens and setting screens are generated using the background image and the object image.

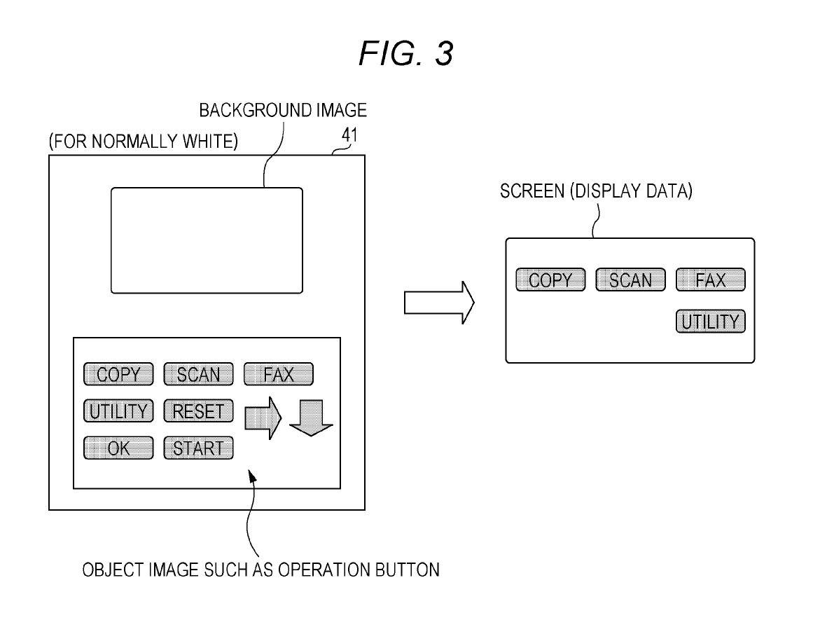

FIG. 3 is a diagram illustrating a scene in which, in a case where an image obtained by combining a background image for white mode (for a first image type) and an object image stored in the image component storage 41 is displayed on the display in white mode, display data of a screen with low power consumption is generated. The background image is a white image or a filled image with high luminance, and in a case where each object image is disposed on the background image such as the white image, the object image such as an operation button obtains a contrast equal to or more than a certain level, and has low luminance, as compared with the background image.

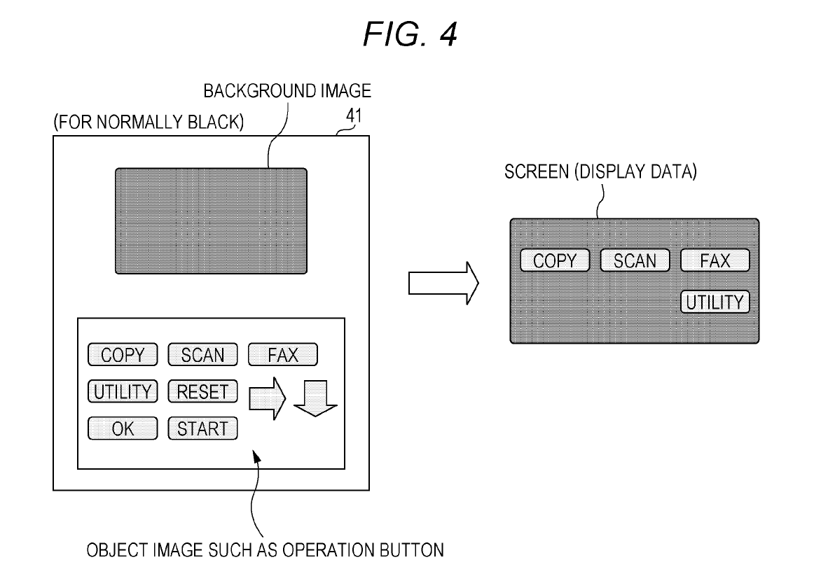

FIG. 4 is a diagram illustrating a scene in which, in a case where an image obtained by combining a background image for black mode (for a second image type) and an object image stored in the image component storage 41 is displayed on the display in black mode, display data of a screen with low power consumption is generated. The background image is a gray image or a filled image with low luminance, and in a case where each object image is disposed on the background image such as the gray image, the object image such as an operation button obtains a contrast equal to or more than a certain level, and has high luminance, as compared with the background image.

For white mode, it is desirable to use an image with high luminance as a whole, and for black mode, it is desirable to use an image with low luminance. However, once the luminance of the entire screen is biased, there is considered a case where visibility to the user is degraded. Therefore, for a partial object image (content image) such as an operation button, a screen with balanced power consumption and visibility is generated by performing devising such as using a reversed color tone against the background.

The color conversion table 42 stored in the HDD 25 is a look-up table for performing color conversion processing (γ conversion, and the like) to an image (an image that is not able to be previously stored in the screen display server 30), which is not able to be generated from the image component storage 41, such as external Web contents and an image read by the image reader 12 and the like, and look-up tables for each screen type is provided. That is, in a case where an image is displayed in the white mode, a color conversion table for the first image type, in which color-conversion is performed on the image to have low power consumption (conversion for increasing luminance as a whole is performed), is provided, and in a case where an image is displayed in the black mode, a color conversion table for the second image type, in which color conversion is performed on the image to have low power consumption (conversion for decreasing luminance as a whole is performed), is provided.

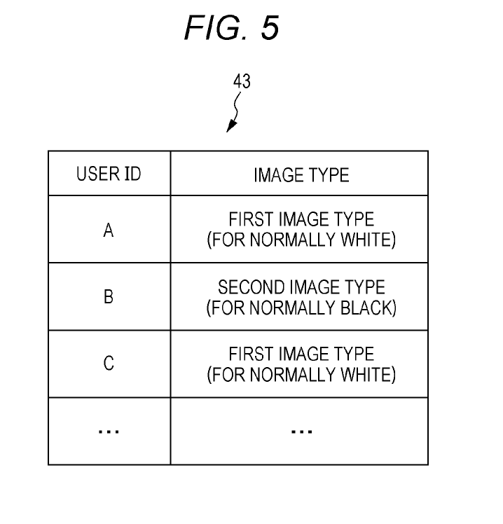

In the setting table 43, as illustrated in FIG. 5, for each user, an image type designated by the user is registered. In the setting table 43 of this example, only the user that designated the image type is registered, and the user that does not designate the image type is not registered.

For each model of the client terminal, the model information storage 44 previously stores a display mode of a display of the model.

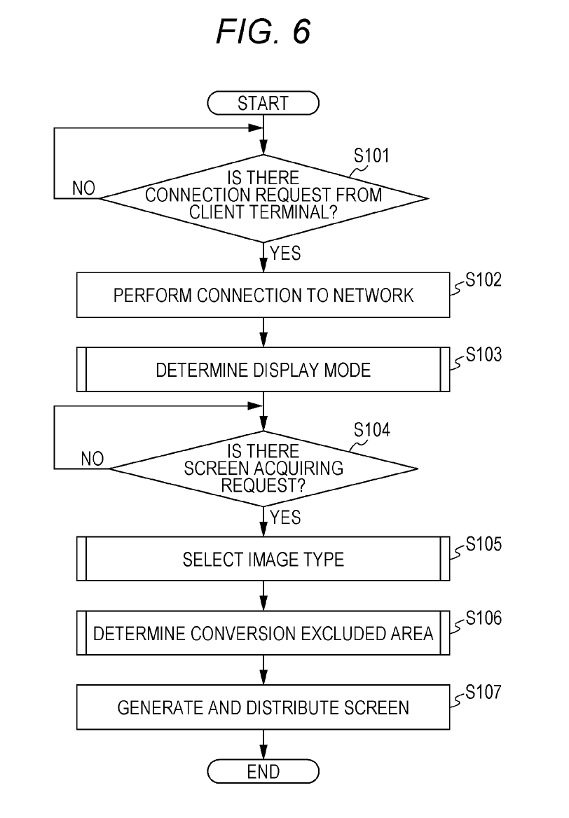

FIG. 6 is a flowchart schematically illustrating operations performed in a case where the image forming apparatus 10 receives a screen acquiring request from the client terminals 3 and 5. Once the screen display server 30 accepts a connection request from the client terminal (step S101; Yes), the screen display server performs connection processing (step S102), and determines a display mode of the connected client terminal (step S103). Thereafter, in a case where a screen acquiring request is received from the client terminal (step S104; Yes), the image type is selected (step S105), and an area to be excluded from the color conversion processing when a screen is generated is determined (step S106). Then, display data of the requested screen of the image type selected in step S105 is generated and distributed to the client terminal through the network to be displayed (step S107). Incidentally, the display data is generated using the contents (background image or object image) stored in the image component storage 41, or is generated by performing color conversion processing on an original image using the conversion table 42. In the latter, color conversion is performed on an area other than an area excluded in step S106. Since color fidelity is required in a preview of an image read by the image reader 12, an image to be printed, or the like, color conversion is not performed.

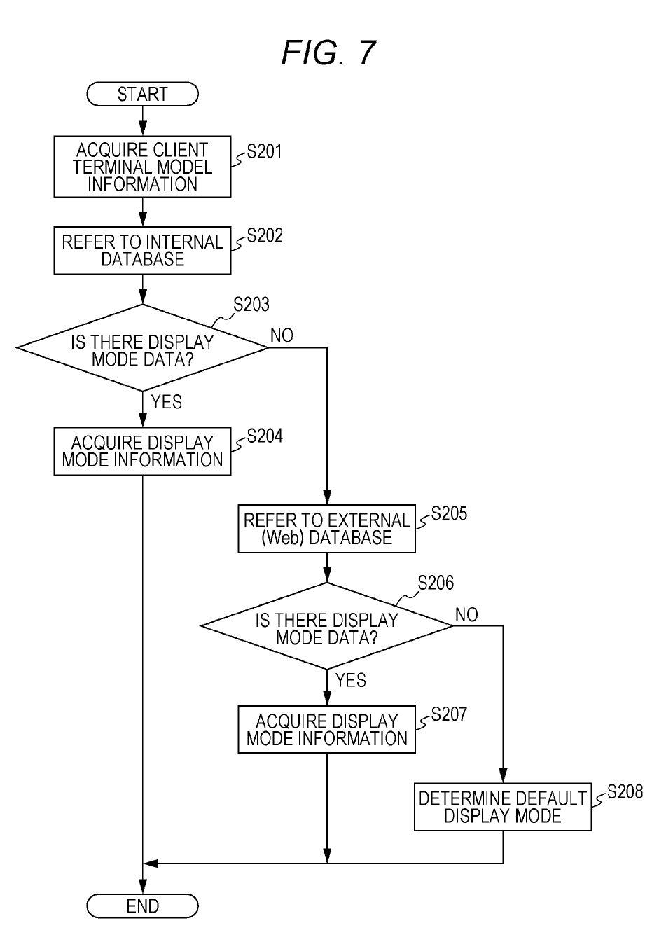

FIG. 7 is a flowchart illustrating the details of step S103 in FIG. 6. The screen display server 30 acquires individual identification information on which the model of the terminal is designatable, from the client terminal. As the individual identification information, information such as a model number, a manufacturer and seller, a serial number, and a lot number of the terminal, that is, information sufficient to designate the display mounted on the terminal, is used.

The screen display server 30 examines the display mode of the display of the model by referring to the model information storage 44 with the model designated using the acquired individual identification information. In a case where the display mode is designatable by referring to the model information storage 44 (step S203; Yes), the display mode information is acquired from the model information storage 44.

In a case where the required information is not provided in the model information storage 44 (step S203; No), the external database is referred to, through the network (step S205). In a case where the display mode is designatable by referring to the external database (step S206; Yes), the display mode information is acquired from the external database (step S207). In a case where the display mode is not designatable by referring to the external database (step S206; No), the display mode information stored as a default setting in the screen display server 30 is selected (step S208).

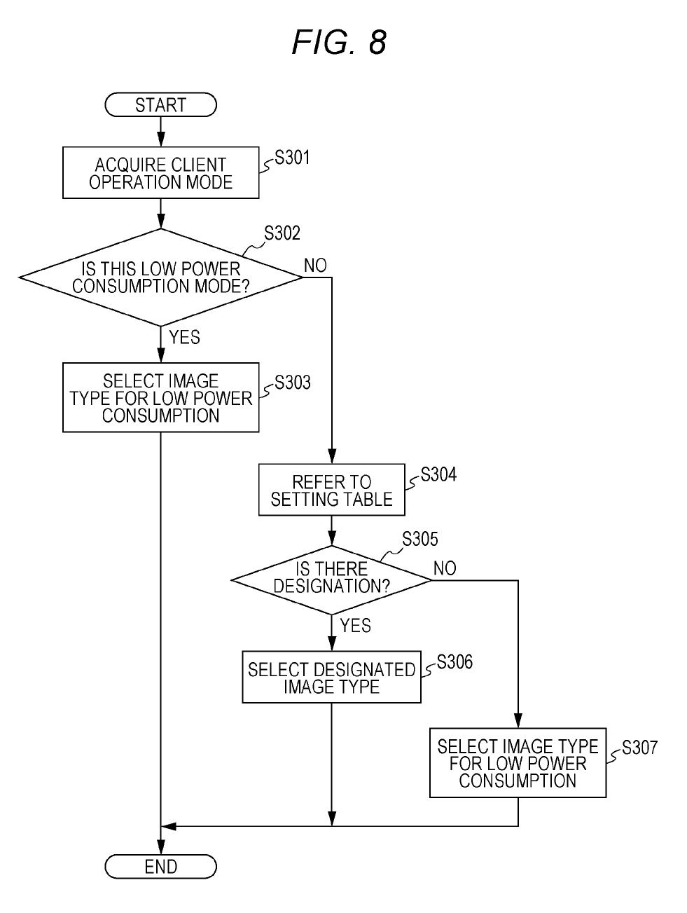

Next, the processing of selecting an image type (step S105 in FIG. 6) will be described. FIG. 8 is a flowchart illustrating the above processing. The screen display server 30 acquires current operation mode information, from the client terminal (step S301). In a case where the operation mode of the client terminal is low power consumption mode (step S302; Yes), an image type with the lowest power consumption in the display mode of the client terminal is forcibly selected (step S303). For example, in a case where, in the client terminal of the white mode, the operation mode is the low power consumption mode, the first image type is selected. In this case, for example, the contents illustrated in FIG. 3 are used for generating display data of the screen.

In a case where, in the client terminal the operation mode becomes a mode other than the low power consumption mode (step S302; No), the setting table 43 is referred to (step S304), and it is determined whether or not the user of the client terminal is a user registered in the setting table 43 (step S305). In a case where the user of the client terminal is a user registered in the setting table 43, the user selects the image type designated by the setting table 43 (step S306).

For example, in a case where the user of the client terminal designates the second image type (for the black mode) in the setting table 43, even if the display mode of the display of the client terminal designated from the model of the client terminal is the white mode, a second image type with low power consumption in the black mode is selected. In this case, for example, the contents illustrated in FIG. 4 are used for generating display data of the screen.

On the other hand, in a case where the user of the client terminal is not registered in the setting table 43 (step S305; No), that is, in a case where the user does not designate the image type, the image type with the lowest power consumption in the display mode of the client terminal is selected (step S307).

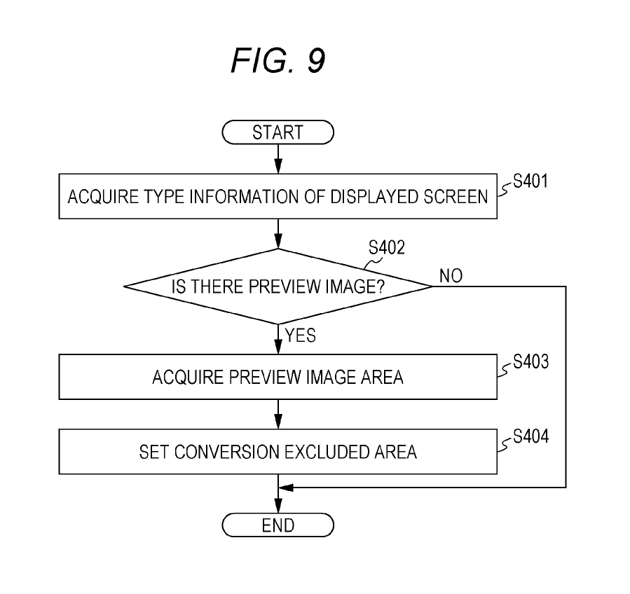

FIG. 9 is a flowchart illustrating details of a conversion excluded area determination processing (step S106 in FIG. 6). Herein, an example, in which color conversion is excluded from a preview image in a case where a scan function or a print function as a function of the image forming apparatus 10 is used, will be described. Incidentally, a target to exclude color conversion is not limited to the preview image, but may include any content in which appearance changing is not preferred for the user, and it is possible to improve convenience by performing conversion excluded area determination. The target to exclude color conversion includes an image that is read out using an image reading function, an image to be printed, and the like.

The screen display server 30 acquires type information of a requested screen from the client terminal (step S401) and determines whether or not a preview image of the scan function or the print function is included in the requested screen (step S402).

In a case where the preview image is included (step S402; Yes), area information such as a position and size of the preview image is acquired (step S403), and an area, in which the preview image is displayed, is set to a color conversion excluded area (step S404). In this way, in a case where the display data of the screen is generated in step S107 of FIG. 6, the color conversion processing accompanied by the appearance changing is not performed on the excluded area.

Next, in a case where the user of the client terminal performs an operation using the operation display 14 of the image forming apparatus 10, a case where the image type of the screen displayed on the operation display 14 of the image forming apparatus 10 is controlled to be the same as the image type of the screen normally displayed on the client terminal of the user will be described.

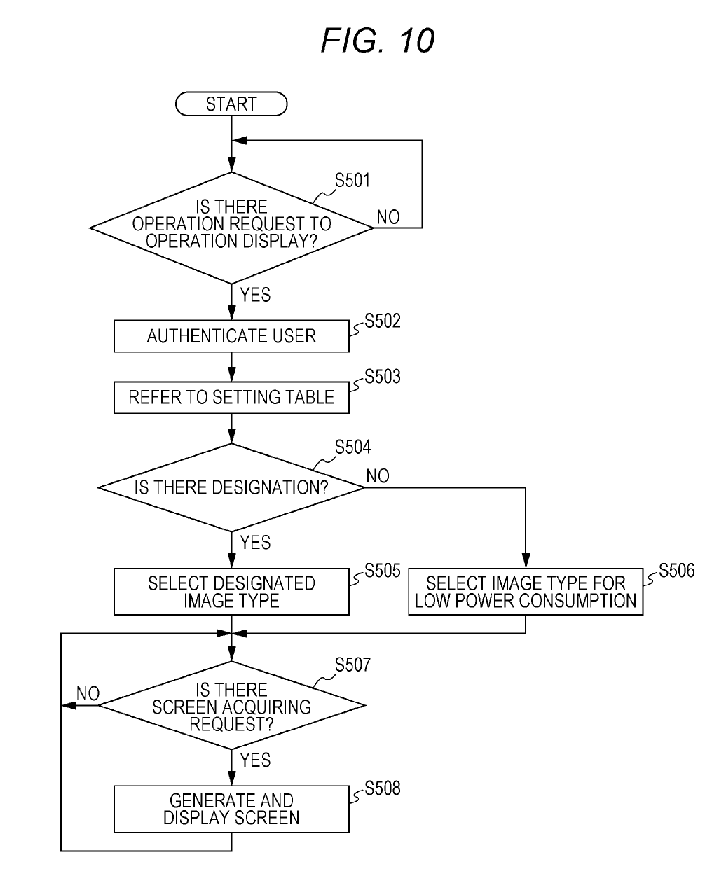

FIG. 10 is a flowchart illustrating operations performed in a case where an operation is received and a screen is displayed on the operation display 14 of the image forming apparatus 10. Herein, it is considered that a screen is displayed also in the operation display 14 of the image forming apparatus 10 using the WebUI function provided by the screen display server 30.

Incidentally, a separate display controller may be provided as a function of the CPU 21 and configured to perform the processing of FIG. 10.

After the screen display server 30 of the image forming apparatus 10 accepts an operation request to the operation display 14 (step S501; Yes), user authentication is performed using the authenticator 16 (step S502). At this time, the screen display server 30 refers to the previously set and stored setting table 43, in which a user is registered and managed in association with an image type designated for screen display on the client terminal normally used by the user (step S503).

In a case where the image type designated by the user is registered in the setting table 43 (step S504: Yes), the designated image type is selected (step S505), and in a case where the image type designated by the user is not registered in the setting table (step S504; No), a display mode of the display of the client terminal normally used by the user is designated by referring to the user information storage 45, and in a case where display is performed in the display mode, an image type with the lowest power consumption as possible is selected (step S506). Thereafter, in response to a request from the operation display 14, operations of generating and displaying a screen as the selected image type are continued.

In the above operations, in a case where the screen is displayed on the operation display 14 of the image forming apparatus 10, in response to a request of a screen from the client terminal used by the user authenticated by the authenticator 16, the same image type as the image type selected by the image type selector 33 through the processing of FIG. 8, is selected and a screen of that image type is displayed on the operation display 14. In this way, since, on the operation display 14 of the image forming apparatus 10, the user can use the operation screen of the same image type as that of the operation screen of the client terminal usually used, consistency is secured and it is possible for the user to operate both screens without feeling uncomfortable.

<Others>

In the processing of step S105, the image type is selected based on a model of the client terminal, a presence or absence of designation in the setting table 43, or the like (either the first image type suitable for the white mode or the second image type suitable for the black mode is selected), but the designation of the image type may be included in a request received by the request receiver 31 from the client terminal. In this case, when the designation of the image type is included in the received request, the screen display server 30 generates display data of a screen as the designated image type, regardless of the display mode of the display of the client terminal. The client terminal may accept the designation of the image type to be included in the request from the user, or may automatically determine the image type based on the surrounding environment (brightness and temperature), and the like.

For example, even if the display mode is the black mode, in a case where the surrounding brightness is equal to or less than a certain level, the screen display of a black main theme is easily visible for a user. Therefore, automatic switching of the image type on a screen display server 30 side is prevented by including the image type in the request from the client terminal, and even if the terminal has the white mode, a black background screen (display data of the image type suitable for the black mode) is requested from a terminal side.

In a case where the request received by the request receiver 31 includes information on the surrounding environment of the client terminal which is a transmission source of the request, regardless of a display mode indicated by the display mode information acquired by the display mode information acquirer 32, the screen display server 30 may be operative to select an image type according to the information on the surrounding environment, to generate display data of a screen as the selected image type, and to provide the display data to the client terminal.

For example, in a case where the surroundings are dark, even if the display mode of the display is white mode, the display data of the image type suitable for the black mode is transmitted to the client terminal. Further, in a case where, in the client terminal, an ambient temperature is high, it is desired to operate with lower power consumption. Therefore, in a case where the ambient temperature of the client terminal is equal to or more than a certain temperature, the screen display server 30 may select an image type with the lowest power consumption regardless of the designation in the setting table 43.

Although embodiments of the present invention have been described with reference to the drawings, specific configurations are not limited to those illustrated in the embodiments, and the present invention includes modifications and additions within a scope without departing from the spirit of the present invention.

In one or more embodiments, the present invention is described as the screen display server 30, but the present invention may be a program causing the information processing apparatus to function as the screen display server 30.

In one or more embodiments, there has been described an example in which color conversion for an image or a screen that cannot be generated from the image component storage 41 is performed using the color conversion table 42, but color conversion required for all images and screens may be performed using the color conversion table 42.

In one or more embodiments, in a case where the image type is selected, it is determined whether or not the client terminal is in the low power consumption mode, but the remaining battery level of the client terminal may be determined. That is, in a case where the remaining battery level of the client terminal which is the transmission source of the request received by the request receiver 31 is equal to or less than a predetermined value, regardless of the designation in the setting table 43, the screen display server 30 selects the image type with the lowest power consumption.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A screen display server comprising:
a hardware processor that:
accepts a request for display data of a screen from a client terminal;
acquires display mode information of a display of the client terminal;
selects, when display is performed on the display with a display mode indicated by the acquired display mode information, an image type from a plurality of predetermined image types that has the lowest power consumption related to display; and
generates the display data of the screen based on the selected image type and provides the generated display data to the client terminal.

2. The screen display server according to claim 1, wherein the display mode indicated by the display mode information includes white mode and black mode.

3. The screen display server according to claim 2, wherein, when the display mode indicated by the acquired display mode information is the white mode, the hardware processor selects a high average luminance image type from the predetermined image types.

4. The screen display server according to claim 1, further comprising:
an image component storage that stores a screen background image and an object image to overlap with the background image for each of the predetermined image types,
wherein the hardware processor generates the display data of the screen to be provided to the client terminal using the background image and the object image corresponding to the selected image type.

5. The screen display server according to claim 4, wherein
the image component storage stores:
a first background image and an object image corresponding to the first background image, in association with a first image type, and
a second background image with lower luminance than the first background image and an object image corresponding to the second background image, in association with a second image type, and
the hardware processor selects:
the first image type when the display mode indicated by the acquired display mode information is white mode, and
the second image type when the display mode is black mode.

6. The screen display server according to claim 1, further comprising:
a color conversion table storage that stores a color conversion table for each of the predetermined image types,
wherein the hardware processor generates the display data of the screen to be provided to the client terminal using a color conversion table corresponding to the selected image type.

7. The screen display server according to claim 6, wherein the hardware processor does not perform color conversion on the contents when contents unsuitable for color conversion with a color conversion table corresponding to the selected image type are provided in the screen where the request for the display data from the client terminal is received.

8. The screen display server according to claim 7, wherein the contents unsuitable for the color conversion are an image that is read out using an image reading function.

9. The screen display server according to claim 7, wherein the contents unsuitable for the color conversion are an image for previewing an image to be printed.

10. The screen display server according to claim 1, wherein, when the request includes a designation of the image type, the hardware processor selects the designated image type from among the predetermined image types regardless of the display mode indicated by the acquired display mode information.

11. The screen display server according to claim 1, wherein, when the request received by the hardware processor includes information on a surrounding environment of the client terminal, the hardware processor selects an image type among the predetermined image types based on the information of the surrounding environment regardless of the display mode indicated by the acquired display mode information.

12. The screen display server according to claim 1, further comprising:
a setting table where the designation of the image type is previously registered with a user,
wherein, when a user of the client terminal is registered in the setting table, the hardware processor selects an image type from the predetermined image types that is registered in the setting table to the user of the client terminal regardless of the display mode indicated by the acquired display mode information.

13. The screen display server according to claim 12, wherein, when a remaining battery level of the client terminal is equal to or less than a predetermined value, the hardware processor selects an image type among the predetermined image types with the lowest power consumption even if the user of the client terminal is registered in the setting table.

14. The screen display server according to claim 12, wherein, when the client terminal is operative in a low power consumption mode, the hardware processor selects an image type among the predetermined image types with the lowest power consumption even if the user of the client terminal is registered in the setting table.

15. The screen display server according to claim 1, further comprising:
a model information storage that previously stores, for each model of the client terminal, a display mode associated with a display of the model,
wherein the hardware processor acquires information of the model from the client terminal and designates the display mode associated with the model by referring to the model information storage.

16. The screen display server according to claim 15, wherein the information of the model includes at least one of a manufacturer or a distributor, a model number, a serial number, and a manufacturing lot number of the client terminal.

17. The screen display server according to claim 1, further comprising:
an operation display that displays a screen and accepts an operation;
an authenticator that authenticates a user that uses the operation display; and
a display controller that controls screen display on the operation display,
wherein the display controller displays a screen of the same image type as the selected image type on the operation display in response to a screen request from a client terminal used by the user authenticated by the authenticator.

18. A non-transitory recording medium storing a computer readable program that causes an information processing apparatus to function as the screen display server according to claim 1.
